(19) United States
(12) Patent Application Publication
(10) Pub. No.: US 2009/0327890 A1
(43) Pub. Date: Dec. 31, 2009

(54) GRAPHICAL USER INTERFACE (GUI), DISPLAY MODULE AND METHODS FOR DISPLAYING AND COMPARING SKIN FEATURES

(75) Inventors: Frederick C. Mertz, San Diego, CA (US); Robert J. Francis, Huntsville, AL (US); Clayton W. Bowersox, San Diego, CA (US); Paula J. Solima, San Diego, CA (US); Karleen Seybold, Tucson, AZ (US)

Correspondence Address: SCHWEGMAN, LUNDBERG & WOESSNER, P.A., P.O. BOX 2938, MINNEAPOLIS, MN, 55402, US

(73) Assignee: Raytheon Company, Waltham, MA (US)

(21) Appl. No.: 12/147,081

(22) Filed: Jun. 26, 2008

(51) Int. Cl. G06F 3/00

(52) U.S. Cl. 715/716; 715/762

(57) ABSTRACT

Embodiments of a graphical user interface (GUI), display module, and method for displaying and comparing skin features are generally described herein. A pose panel may display a body outline or thumbnail image of one of several body poses and may identify one or more alerts. Each alert may identify skin features that have been identified as changed. An alert image panel may display a higher-resolution image of the alert selected in the pose panel showing identified skin features. An alert information panel may display alert data associated the alerts and may indicate a review status associated with the alerts. An alert notes panel may display notes associated with a selected alert. The GUI may be configured to systematically display the alerts associated with the poses in sequence to automate and help expedite the process of reviewing identified skin-features.

### CROSS-REFERENCE TO RELATED APPLICATIONS

This patent application claims priority to U.S. patent application Ser. No. 12/133,163, filed Jun. 4, 2008 entitled “IMAGE PROCESSING SYSTEM AND METHODS FOR ALIGNING SKIN FEATURES FOR EARLY SKIN CANCER DETECTION SYSTEMS” having attorney Docket No. 1547.051US1, the entire contents of which are incorporated by herein by reference.

### TECHNICAL FIELD

Some embodiments pertain to graphical user interfaces (GUIs) and display systems. Some of these embodiments pertain to GUIs and display systems for displaying and comparing skin features. Some embodiments may be suitable for use with skin cancer detection systems.

### BACKGROUND

Skin cancer is an increasing health problem globally with over one million new cases diagnosed each year in the United States alone, including almost 60,000 new cases of melanoma, the most serious form of skin cancer, and more than 8,000 deaths. Despite significant fundamental and clinical research efforts, the treatment of advanced melanoma has only shown minimal impact on the overall prognosis for this disease. The focus on skin cancer traditionally has been on improved treatments for the final stages and prevention. The statistics indicate that most resources are expended on skin cancer in the later stages where the probability is lower for a full recovery. It may be beneficial to the public and the health care insurance industries to shift resources to early skin cancer detection where probabilities increase significantly for survival and a continued productive life.

One difficulty with skin cancer detection is that there are no objective methods for skin cancer screening available for use in a clinical setting. Conventionally, skin cancer screening is performed by combining visual observations with manual handwritten tracking methods done locally in a physician's office. Digital photography has been used by some dermatologists and patients to help identify skin changes, but it remains difficult to compare baseline images to lesions observed at the time of a skin examination. One of the more important melanoma risk factors are persistently changing moles in size, and color, and the presence of a large number of moles of at least a certain diameter. The difficulty of imaging the human body over time, aligning features of the images, and comparing those images in a reliable, and clinically useful way is not currently available.

Thus, there are general needs for GUI's and methods for displaying and comparing skin features that may be suitable for use with skin cancer detection systems. There are general needs for systems and methods for precisely aligning skin features in images captured over time and detecting changes in the skin features using a GUI.

### BRIEF DESCRIPTION OF THE DRAWINGS

FIG. 1 illustrates a graphical user interface (GUI) in accordance with some embodiments;

FIG. 1A illustrates a pose panel and an alert image panel of the GUI of FIG. 1 in accordance with some embodiments;

FIG. 2 illustrates a pose panel of the GUI of FIG. 1 in accordance with some embodiments;

FIG. 2A illustrates a pose-selection panel of the GUI of FIG. 1 in accordance with some embodiments;

FIG. 3 illustrates an alert image panel of the GUI of FIG. 1 in accordance with some embodiments;

FIG. 4 illustrates an alert information panel of the GUI of FIG. 1 in accordance with some embodiments;

FIG. 5 illustrates a spotlight-notes dialog panel of the GUI of FIG. 1 in accordance with some embodiments;

FIG. 6 illustrates an alert notes panel of the GUI of FIG. 1 in accordance with some embodiments;

FIG. 7 illustrates a verification pair panel of the GUI of FIG. 1 in accordance with some embodiments;

FIG. 8 is a block diagram of display system in accordance with some embodiments; and

FIG. 9 illustrates a data storage element in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in, or substituted for those of other embodiments. Embodiments set forth in the claims encompass all available equivalents of those claims.

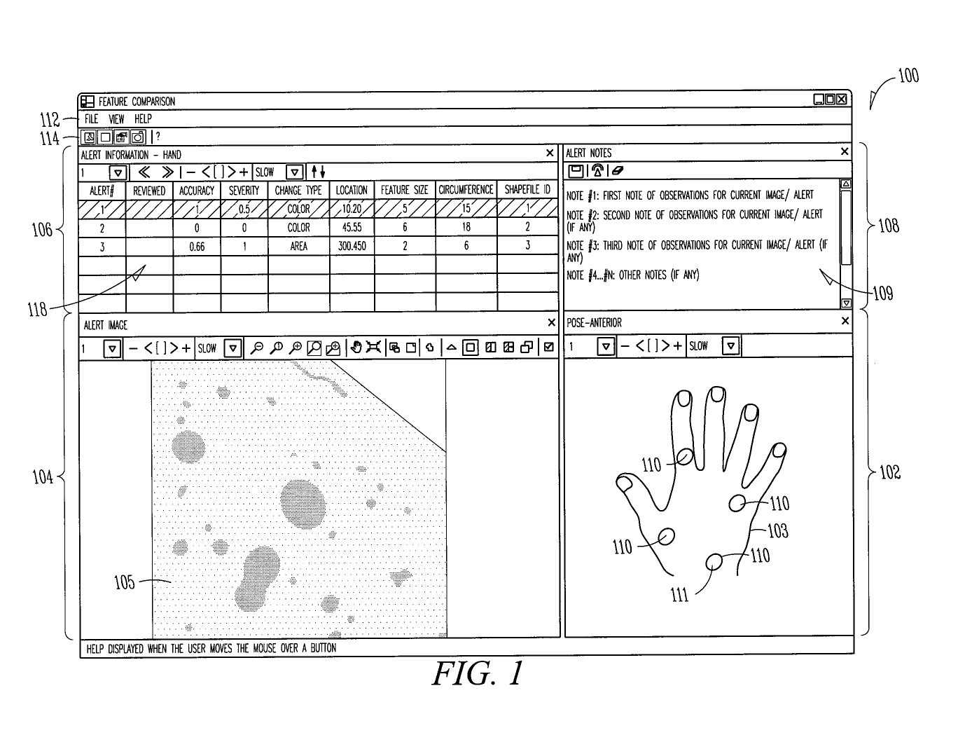

FIG. 1 illustrates a graphical user interface (GUI) in accordance with some embodiments. GUI 100 may be suitable for use in displaying and comparing corresponding skin features that may have been identified by a skin cancer detection and/or screening system, although the scope of the embodiments is not limited in this respect. GUI 100 may include pose panel 102, alert image panel 104, alert information panel 106, and alert notes panel 108.

In accordance with some embodiments, corresponding skin features between a reference image and a later-captured image may have been aligned and registered by a skin-feature change detection system to allow images of the corresponding skin features that have been identified as changed to be retrieved and displayed in alert image panel 104. In accordance with some embodiments, GUI 100 may allow an analyst to view these corresponding images, which may be generated by a display module. The display module may provide information to the analyst in a report display format that may, for example, indicate changes detected in skin features, such as pigmentation. GUI 100 may provide the capability to view imagery of poses and alert areas in detail along with a corresponding report of each alert in a spreadsheet format. Current images may be easily compared with previous imagery, for example, using a time series of multiple images or a swipe of two selected images (e.g., a flicker or movie). GUI 100 may also provide general image enhancement tools including, for example, brightening, zooming and panning tools. Once an alert is reviewed, its status may be marked in a spreadsheet, and the next alert location may be automatically displayed. Notes may also be added for each alert. In accordance with some embodiments, each panel (e.g., pose panel 102, alert image panel 104, alert information panel 106, and alert notes panel 108) may be resized individually to optimize screen space. These embodiments are discussed in more detail below.

Pose panel 102 may be configured to display pose image 103 of one of a plurality of body poses. Pose image 103 may comprise a body outline as shown in FIG. 1, or pose image may comprise a thumbnail image. The thumbnail image may be a color or B&W image. In some embodiments, pose panel 102 may be configured to display some or all of the pose images to provide the user the ability to graphically select a pose of interest. Pose panel 102 may also identify one or more alerts 110. Each alert 110 may outline a region that includes one or more skin features on pose image 103. Although pose panel 102 shows an example of a hand body pose, any one of the various body poses discussed in more detail below may be shown. In some embodiments, a pose selection panel, discussed in more detail below, may be used to display several or all thumbnail images or body outlines for selection by a user, although the scope of the embodiments is not limited in this respect.

Alert image panel 104 may be configured to display higher resolution portion 105 of a body image corresponding to one of alerts 110 or other area selected in pose panel 102. Alert image panel 104 may show the skin features of a selected alert, such as selected alert 111.

Alert information panel 106 may be configured to display alert data in spreadsheet or tabular form. The alert data may be associated with one or more of alerts 110. Alert information panel 106 may include, among other things, reviewed status box 118 to indicate a review status associated with each of alerts 110.

Alert notes panel 108 may be configured to capture and/or display notes 109, associated with an alert, such as selected alert 111. Alert notes panel 108 may be configured to record or playback audio notes associated with an alert. Notes 109, including both text and audio notes, may have been previously input by an analyst based on a review of an alert.

GUI 100 may also include menu bar 112, which may include a file menu, a view menu, and a help menu. The file menu may be used to select data associated with a particular patient and close the application. The view menu may include an alert image selection to hide/show alert image panel 104. If hidden, alert information panel 106 may expand to take up the vacated space. The view menu may include an alert information selection to hide or show alert information panel 106. If hidden, alert image panel 104 may expand to take up the vacated space. The view menu may also include an alert notes selection to hide/show alert notes panel 108. If hidden, pose panel 102 may expand to take up the vacated space. The view menu may also include a pose selection to hide or show pose panel 102. If hidden, alert notes panel 108 may expand to take up the vacated space. The help menu may include an overview selection to display a document or equivalent HTML pages that define the use of the application, among other things.

GUI 100 may also include toolbar 114 that may include one or more icons. For example, an icon may be included to hide or show alert image panel 104, an icon may be included to hide or show alert information panel 106, an icon may be included to hide or show alert notes panel 108, and a icon may be included to hide or show pose panel 102. Toolbar 114 may include additional icons for additional functionality.

In some embodiments, the panels of GUI 100 may be linked to one another. In these embodiments, the windows may be configured to react and display relevant data for the same alert. Pressing the play button on the toolbar of any one of the windows may result in a systematic display of information and images for the same alert in all windows, although the scope of the embodiments is not limited in this respect. For example, alert 111 may be selected in pose panel 102, and the selection of the play button in pose panel 102 may result in the systematic display of relevant information pertaining to alert 111 in image panel 104, alert information panel 106, and alert notes panel 108. In some embodiments, GUI 100 may be configured to systematically display all alerts associated with all poses in sequence to help expedite the process of reviewing identified skin-features.

FIG. 1A illustrates pose panel 102 and alert image panel 104 of a GUI in accordance with some embodiments. Pose panel 102 and alert image panel 104 illustrated in FIG. 1A may be suitable for use as pose panel 102 and alert image panel 104 of FIG. 1. As illustrated in FIG. 1A, pose panel 102 may be configured to display a B&W image of a body pose rather than a body outline as illustrated in FIG. 1. In some embodiments, pose panel may highlight region 107 to correspond to the image illustrated in alert image panel 104. Highlight region 107 may be illustrated with a box or with a highlight color or contrast. In some embodiments, GUI 100 may be configured to allow user to reposition highlight region 107 within pose panel 102 to view the corresponding higher-resolution image in alert image panel 104. The use of highlight region 107 provides the user with an indication of where the image in alert image panel 104 is on the body image, as well as provides the user with the ability to select different areas on the body image for viewing.

Embodiments of the present invention provide interconnectivity among the various panels of GUI 100. For example, when an alert 110 is selected in pose panel 102, alert image panel 104 displays the corresponding higher-resolution image, alert information panel 106 displays the corresponding alert data, and alert notes panel 108 displays the corresponding alert notes. This interconnectivity among the various panels of GUI 100 allows an analysis to quickly and easily view and analyze any portion of an image, including alerts 110.

In some embodiments, GUI 100 may be configured to display a time-history of one or more corresponding images allowing an analyst to view and analyze and track alert sites over time. A database, discussed in more detail below, may be configured to store the associated data for GUI 100.

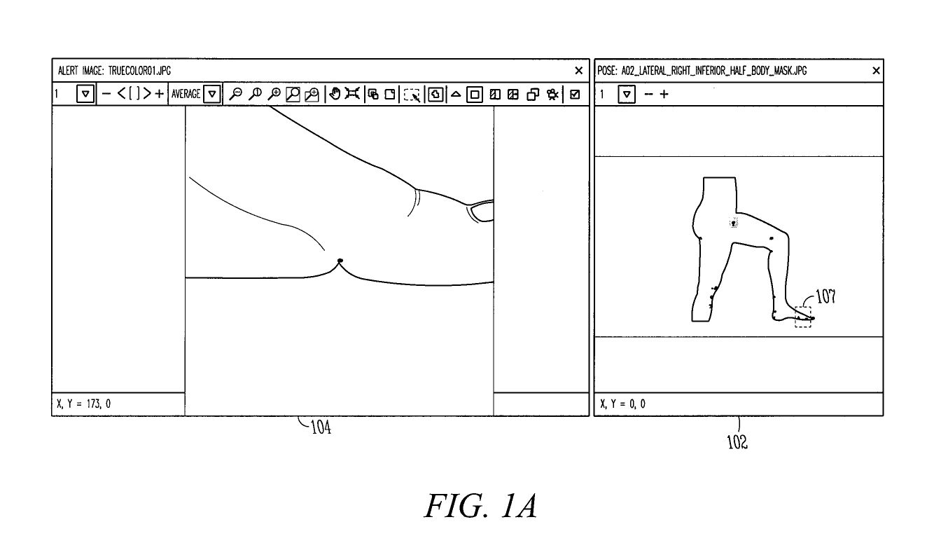

FIG. 2 illustrates a pose panel of a GUI in accordance with some embodiments. Pose panel 200 may be suitable for use as pose panel 102 (FIG. 1) of GUI 100 (FIG. 1). Pose panel 200 may be configured to display pose image 103 of one of a plurality of body poses. Pose panel 200 also may identify one or more alerts 110, each of which may outline a region of one or more skin features that may have been identified as changed. In addition to body outlines, an analyst may select to display color or B&W thumbnail images in pose panel 102 when displaying pose selection panel 250 discussed below. Alerts 110 are included as a graphical overlay in pose panel 200. Using a mouse to select and click on an alert outline in pose panel 200 may result in an update or re-fresh of the other windows of GUI 100, such as alert image panel 104, alert information panel 106 and alert notes panel 108. Pose panel 200 may also include toolbar 202, which may include one or more icons to perform various functions. In some embodiments, an analyst may select a pose via a combo box (e.g., a pull-down) or may loop through the various poses using control buttons on toolbar 202. Selecting an alert area (e.g., by pressing a mouse on an alert area) in pose image 103 may display one or more higher-resolution images associated with the alert in a predetermined resolution (e.g., 1:1) in alert image panel 104 (FIG. 1).

In some embodiments, each alert 110 identified on pose panel 200 may outline a region on pose image 103 associated with one or more skin features that have been identified as changed, although the scope of the embodiments is not limited in this respect. In some embodiments, alerts 110 may comprise circles, ovals, or irregular shapes identifying a region on pose image 103.

In some example embodiments, toolbar 202 includes icon 204 which may hide or close pose panel 102. Toolbar 202 may also include current pose identifier and description box 206 which may display the current pose identifier (e.g., pose #1-14) and a descriptor. Description box 206 may include a pull-down to allow the selection of the pose identifier and descriptor. Toolbar 202 may also include icon 208 to step backward to the previous pose, icon 210 to loop through the poses in reverse order, and icon 212 to stop looping (i.e., pause) through the poses. Toolbar 202 may also include icon 214 to step thorough the poses in ascending order, icon 216 to step forward to the next pose, box 218 to change and display speed options, and pose-all icon 251 to enable a pose-selection panel. Examples of speed options include slow, average, and fast speed options for looping through the poses.

Although pose panel 200 illustrates only a single B&W image, as discussed above, pose panel 200 may be configured as a pose-selection panel to show several or all B&W or color thumbnail images to allow an analyst to graphically select a pose of interest. An example of this is illustrated in FIG. 2A. FIG. 2A illustrates pose-selection panel 250. In these embodiments, pose-selection panel 250 may be enabled by selecting pose-all icon 251 in pose panel 200 (FIG. 2). When one of the thumbnail images in pose-selection panel 250 is selected, GUI 100 may display the selected pose in pose panel 200. In some embodiments, pose-selection panel 250 may display outlines or stick figures illustrative of the particular poses instead of actual thumbnail images. Among other things, pose-selection panel 250 may include icon 253 to hide or close panel 250.

In some embodiments, the body pose that may be displayed in outline form in pose panel 200 may include one or more body poses for which image sets may have been captured. Some examples of the body poses may include:

a full body front body pose (head to ankles) with arms at a ninety-degree angle at shoulders (i.e., a stick-up pose), eyes closed, fingers open, and legs apart;

a full body back body pose (head to ankles) with arms at a ninety-degree angle at shoulders (i.e., also a stick-up pose), fingers open, and legs apart;

a half body upper front body pose (head to navel) with arms at a ninety-degree angle at shoulders (i.e., also a stick-up pose), eyes closed, and fingers open;

a half body upper back body pose (head to mid back) with arms at a ninety-degree angle at shoulders (i.e., also a stick-up pose), and fingers open;

a half body lower front body pose (navel to ankle) with arms folded up on chest and out of the way, and legs apart;

a half body lower back body pose (mid back to ankles) with arms folded up on chest and out of the way, and legs apart;

a left side full body pose (head to ankles) with the right leg bent at a forty-five degree angle and a foot placed up on a stool, right hand placing flat end of dowel on palm and resting other flat end on right knee, left arm positioned back away from the body, and eyes closed;

a right side full body pose (head to ankles) with left leg bent at a forty-five degree angle and foot placed up on the stool, left hand placing flat end of dowel on palm and resting other flat end on left knee, right arm positioned back away from the body, and eyes closed;

a left side half upper body pose (head to hips) with right leg bent at a forty-five degree angle and foot placed up on the stool, right hand placing flat end of dowel on palm and resting other flat end on right knee, left arm positioned back away from the body, and eyes closed;

a right side half upper body pose (head to hips) with left leg bent at a 45 degree angle and foot placed up on the stool, left hand placing flat end of dowel on palm and resting other flat end on left knee, right arm positioned back away from the body, and eyes closed;

a left side half lower body pose (hips to ankles) with right leg bent at a 45 degree angle and foot placed up on the stool, and arms folded up on the chest and out of the way;

a right side half lower body pose (hips to ankles) with left leg bent at a 45 degree angle and foot placed up on the stool, and arms folded up on the chest and out of the way;

a feet body pose having the feet slightly apart and on a plastic background grid marked for distance between feet; and

a hands body pose having the hands slightly apart and held above a background in which the thumbs touch and/or are separated by a predetermined distance between hands.

Other poses, for example, may include feet-top and feet-bottom poses, hands-top and hands-bottom poses, and head-front (face), head-top, head-back, head-left side and head-right side poses. In some embodiments, the hands and the feet body poses may have been captured with different photographic equipment than the other body poses due to the different distances involved with the imaging. In some embodiments, the several body poses described above may be sufficient to image the human body. Although only certain body-poses are disclosed, the scope of the embodiments are not limited in this respect as a greater or lesser number of body poses may be used. In some embodiments, the stool, the plastic background grid for the feet body pose, and the background for the hands body pose may be a predetermined color (e.g., a particular shade of blue) selected for easy image extraction. In some embodiments, various techniques using laser-positioning may be implemented to help assure that corresponding body images taken at different times are accurately replicated so that corresponding features can be aligned.

In some alternate embodiments, rather than displaying only a body outline of a particular pose, such as pose image 103, pose panel 102 may display a lower-resolution body image within pose image 103, although the scope of the embodiments is not limited in this respect.

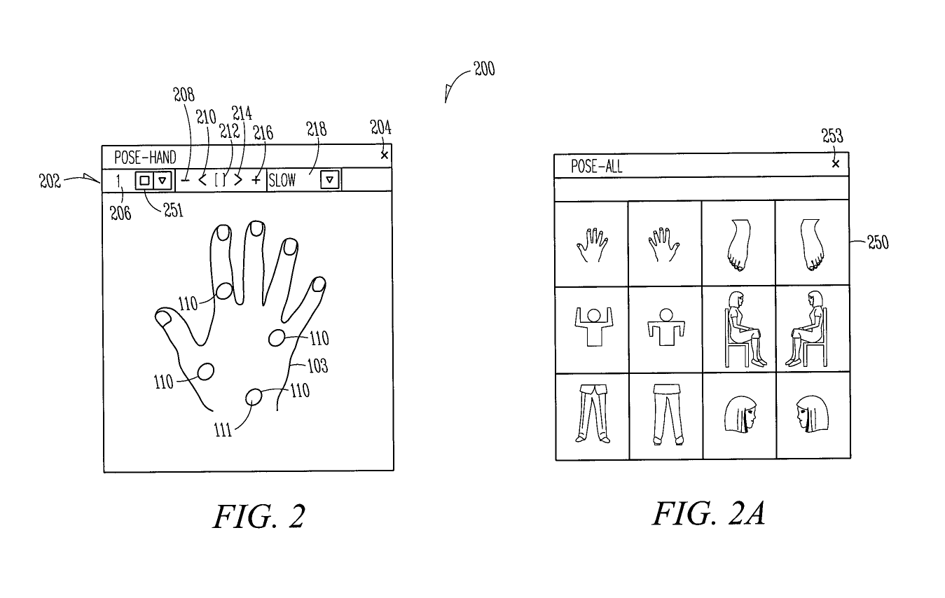

FIG. 3 illustrates an alert image panel of a GUI in accordance with some embodiments. Alert image panel 300 may be suitable for use as alert image panel 104 (FIG. 1). Alert image panel 104 may display higher resolution portion 105 of a body image corresponding to one of alerts 110 selected in pose panel 102. Portion 105 may show skin features of a selected alert, such as selected alert 111. In some embodiments, alert image panel 104 may include, among other things, a toggle feature to allow an analyst to toggle between corresponding portions of the body image associated with selected alert 111 from a reference image and a later-captured or current image for comparison of corresponding skin features. The toggle feature, for example, may allow an analyst to perform a visual comparison of a feature in the reference image with a corresponding feature in the later-captured image. Alert image panel 300 may also include a zoom feature to expand the region associated with selected alert 111. In some embodiments, alert image panel 300 may display full resolution images associated with selected alert 111. Additional functions, such as panning, may also be provided by alert image panel 300. In some embodiments, alert image panel 300 also may allow an analyst to cycle to a previous or next alert image as well as compare a current alert image with an original view of the same region. In some embodiments, GUI 100 may be configured to update or re-fresh pose panel 102, alert information panel 106, and alert notes panel 108 using the looping options to view an alert in alert panel 300.

Alert image panel 300 may include toolbar 302 which may include one or more icons for configuring panel 300 and/or GUI 100. For example, toolbar 302 may include icon 303 to hide or close alert image panel 300. Toolbar 302 may include an icon to select an alert identifier (e.g., a number) which may include a pull-down to allow selection of one of alerts 110. Toolbar 302 may also include icons to step forward (e.g., icon 309) or backward (e.g., icon 305) to an alert image set, icons to automatically and systematically loop through all alert image sets in descending order (by selection of icon 306) or ascending order (by selection of icon 308) until selection of stop looping icon 307. The ascending or descending order may be based on various criteria such as size, type, area, number or other information in alert information panel 106.

Toolbar 302 may also include box 304 to display a current alert identifier (e.g., a number) which may include a pull-down to allow selection of one of alerts 110. Toolbar 302 may also include box 310 to display speed options, such as slow, average, and fast, for looping through the images. Toolbar 302 may also include icon 311 to zoom out from the image, icon 312 to reset the image to a predetermined resolution (e.g., 1:1), icon 313 to zoom into the image, icon 314 to display an entire image subset within alert image panel 300, icon 315 to zoom to an image corresponding to a user-defined box, and icon 316 to provide panning (i.e., moving around) of the image. In some embodiments, toolbar 302 may also include icon 317 to center the current image within alert image panel 300, and icon 318 to display a zoomed version of the image centered at a current cursor position. Toolbar 302 may also include icon 319 to display a zoomed version of the image centered at the current cursor position. Toolbar 302 may also include icon 320 to turn on and off these the display of the alert overlays, and icon 321 to display a user-selected change image. Toolbar 302 may also include icons to change the contrast and brightness of the image for better viewing.

In some embodiments, toolbar 302 may also include icon 322 to display the current or the previous image, icon 323 to display the current and previous images side by side, icon 324 to provide the ability to swipe between two user-selected images, icon 325 to flicker between the current alert image and a user-selected image, and move icon 327 to view two or more user selected time series images as a movie. Toolbar 302 may also include icon 326 to launch a verification image pair panel which may display the two images used to compute change prior to their registration to allow for a side by side for comparison of the actual images.

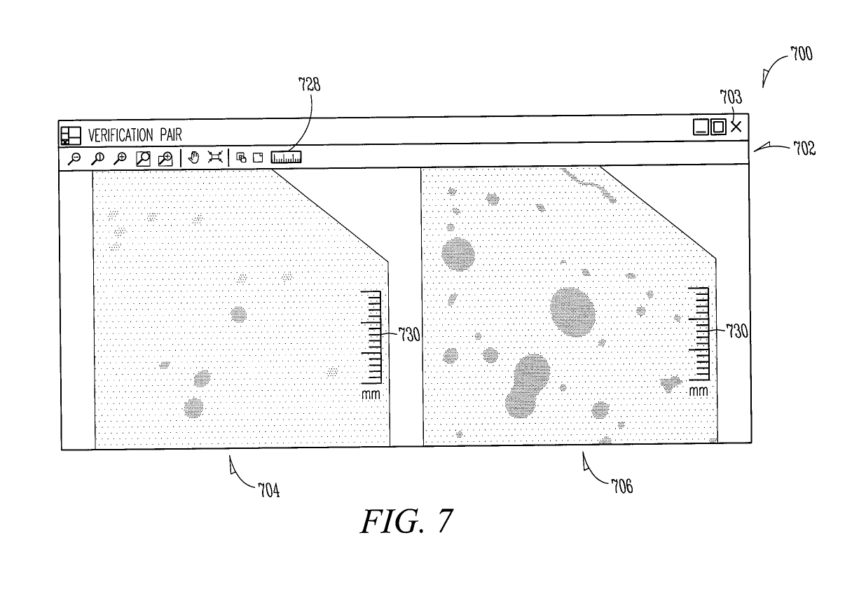

In some embodiments, toolbar 302 may include icon 328 to enable measurement tool 330. Measurement tool 330 may be a pop-up and may be displayed in panel 300 to indicate an actual size (e.g., in millimeters) of the displayed image. In some embodiments, icon 328 may be illustrative of a ruler, and tool 330 may show a ruler type image. The generation of measurement tool 330 may use metadata associated with the alert so that measurement tool can properly show the correct dimension. Measurement tool 330 may be used by an analyst to measure length, to determine circumference, and to determine the area of features displayed in panel 300. Although the various icons of toolbar 302 are illustrated in certain positions in panel 300, these positions may be changed and the icons may be re-ordered. Furthermore, the various icons of toolbar 302 may be provided in separate toolbars. An example verification pair panel, which may be launched by icon 326, is discussed in more detail in FIG. 7.

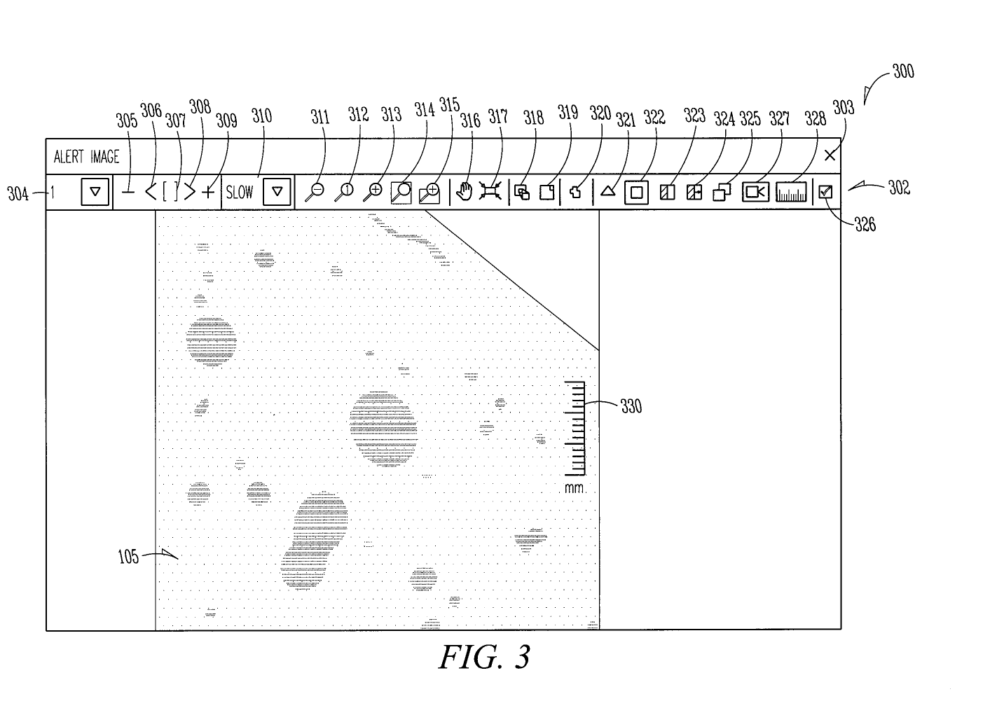

FIG. 4 illustrates an alert information panel of a GUI in accordance with some embodiments. Alert information panel 400 may be suitable for use as alert information panel 106 (FIG. 1). Alert information panel 400 may display alert data 406 associated with one or more of alerts 110 (FIG. 1). Alert information panel 400 include, among other things, reviewed status box 118 to indicate a review status associated with one or more of alerts 110. Reviewed status box 408 may be configured to indicate, after review by an analyst (e.g., a physician) or a patient, one of several concern levels that may be selected for each of alerts 110. In some embodiments, after the review by an analyst, reviewed status box 408 may be configured to indicate a particular color for each of the concern levels. In some embodiments, patient-reviewed images and patient-entered data may be used to aid a physician in the patient-physician exchange during an exam and may help expedite the review process.

In some embodiments, the concern levels may comprise a higher concern level (e.g., a likely concern), a lower concern level (e.g., a potential concern), and an unconcerned level (e.g., not likely a concern). Reviewed status box 408 may also indicate a review status of “not reviewed” prior to a review of an associated alert 110 by the analyst.

In some embodiments, the color displayed by reviewed status box 408 may be red when the higher concern level is selected for selected alert 111, the color displayed by reviewed status box 408 may be yellow when the lower concern level is selected, and the color displayed by reviewed status box 408 may be green when the unconcerned level is selected, although the scope of the embodiments is not limited to any particular colors. In these embodiments, reviewed status box 408 may be blank prior to review by an analyst.

In some embodiments, alert data 406 displayed by alert information panel 400 may be displayed in spreadsheet form and may include one or more columns as described herein, although the scope of the embodiments is not limited in this respect. In some embodiments, alert data 406 may include change type field 418 to indicate whether an associated alert had been identified as having a color change, a shape change or an area change. Alert data 406 may also include feature size field 422 to indicate an approximate size of a skin feature associated with an alert. Feature size field 422 may indicate the size of the change feature (e.g., in square millimeters). Alert data 406 may also include circumference field 424 to indicate an approximate circumference (e.g., in millimeters) of a skin change feature of the associated alert. In some embodiments, alert data 406 displayed by alert information panel 400 may also include accuracy field 414 which may provide an accuracy level of the identified change, severity field 416 which may rate the severity of the identified change, and location field 420 which may indicate the location (e.g., in x-y coordinates in the image) of the skin features that have been identified as changed.

The columns illustrated in spreadsheet of FIG. 4 for alert data 406 may include additional columns for any relevant data associated with the detection, screening, and diagnosis of skin features. In some embodiments, additional columns may be added by an analyst, or columns may be deleted by an analyst. In some embodiments, data may be imported from a spreadsheet or data file. In some embodiments, a database may be used to store a historical record of images and/or prior alerts for a patient. Alternatively, a patient may retain this information in a computer-readable medium, such as on a compact disc or other storage medium and may provide this information for viewing and analyzing using GUI 100. Prior alerts, as well as the associated imagery and information from prior patient visits may be stored in the database or a patient's computer-readable medium.

In some embodiments, a change-detection file may store alert data 406 including coordinates of the skin features associated with each alert 110 in the reference image and the later-captured image that have been identified as changed. In these embodiments, change-detection files may be generated by a skin-feature change detection system, such as the change detection system disclosed as part of a skin-feature change detection system disclosed in US patent application having attorney docket number 1547.051US1 referenced above.

Alert information panel 400 may serve as a primary report window and may be presented to the analyst in spreadsheet form. Selecting or clicking a line in this spreadsheet (i.e., panel 400) may result in the associated image set being displayed in the view panels. Clicking a column header, such as “Alert #” or “Reviewed”, may sort the data using the items in the selected column. The up and down arrows in toolbar 402 may be used to sort the data in either ascending or descending order. Alert information panel 400 may also include toolbar 402 having icons including VCR/DVR-type controls to provide movement up or down through the spreadsheet and to display the associated alert image sets. In some embodiments, when using the VCR/DVR-type controls provided in toolbar 402, an analyst may be prompted to color code each alert in accordance with one of the concern levels discussed above before advancing to the next entry. In some embodiments, the analyst may be prompted to enter notes regarding the alert. In some embodiments, a spotlight-notes dialog panel, discussed in more detail below, may be displayed for note entry.

In some embodiments, the outlines of alerts 110 in pose panel 200 may be displayed in the color associated with the concern level, although the scope of the embodiments is not limited in this respect. In these embodiments, prior to review, alerts 110 may be an initial color not associated with a concern level, and after review, alerts 110 may be red, yellow, or green, depending on the concern level, which corresponds to the color indicated in the associated reviewed status box 408. In some alternate embodiments, alerts 110 identified on pose panel 102 may be displayed in the same color regardless of their review status and concern level.

In addition to the function discussed above, toolbar 402 of alert information panel 400 may include icons having functions similar to the functions of some of the icons previously described. In addition, toolbar 402 may include slider bars to enable scroll capabilities (e.g., up and down, left and right) within the spreadsheet showing alert data 406, although the scope of the embodiments are not limited in this respect. In some embodiments, panel 400 may include icon 403 to hide or close panel 400.

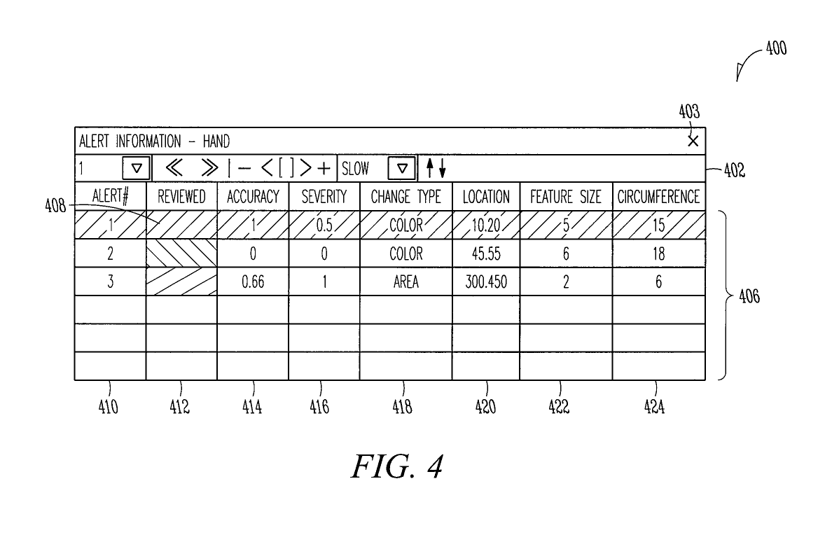

FIG. 5 illustrates a spotlight-notes dialog panel of a GUI in accordance with some embodiments. Spotlight-notes dialog panel 500 may comprise a pop-up window that may be displayed when an analyst selects one of alerts 110 (FIG. 1) within alert information panel 106 (FIG. 1). Spotlight-notes dialog panel 500 may allow an analyst to select one of concern levels 508 and may allow the analyst to add notes 109 (e.g., in text form) in notes portion 512 of spotlight notes dialog panel 500. In these embodiments, spotlight-notes dialog panel 500 may be associated with selected alert 111 (FIG. 1) that is selected in alert information panel 106 (FIG. 1). As described above, concern levels 508 may include higher concern level 508A, which may be indicated by red, lower concern level 508B, which may be indicated in yellow, and unconcerned level 508C, which may be indicated in green. Clicking OK button 513 may save the information entered and may advance spotlight-notes dialog panel 500 to the next alert within the pose or to an alert in another pose. In some embodiments, specific medical/diagnosis codes for skin feature change detection and identification may be used instead of the colors and concern levels discussed above.

Alert notes panel 108 (FIG. 1) may display notes 109 from portion 512 of spotlight-notes dialog panel 500. Notes 109 displayed may also be notes previously input by an analyst and stored in a data storage element (e.g., a database). Notes 109 may be associated with the currently selected alert, such as selected alert 111 (FIG. 1). In some embodiments, spotlight-notes dialog panel 500 may be displayed for each alert 110 of each body pose when looping in alert information panel 106 (FIG. 1) which may require an analyst to enter a review status and any notes for the currently displayed alert image. In these embodiments, imagery and data may have been generated and stored in the data storage element by a skin-feature change detection system, such as the change detection system disclosed as part of a skin-feature change detection system disclosed in US patent application having attorney docket number 1547.051US1 referenced above. In some embodiments, spotlight-notes dialog panel 500 may include icon 503 to close or hide panel 500.

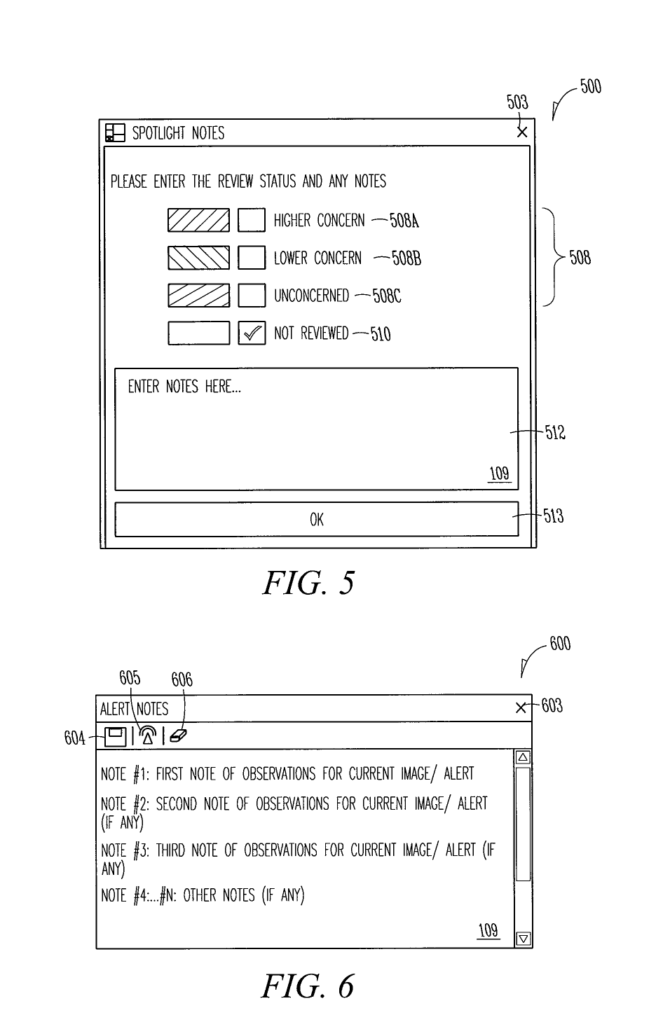

FIG. 6 illustrates an alert notes panel of a GUI in accordance with some embodiments. Alert notes panel 600 may be suitable for use as alert notes panel 108 (FIG. 1). Alert notes panel 600 may display notes 109 from note portion 512 (FIG. 5) of spotlight-notes dialog panel 500 (FIG. 5) that were input by an analyst. Alert notes panel 600 may display all notes associated with the currently displayed alert image and may support entry of new notes, and the retrieval, tracking and editing of old notes.

Alert notes panel 600 may include toolbar 602 that may include icon 603 to hide or close alert notes panel 600, icon 604 to saves notes 109, icon 605 to provide entry of audio notes (e.g., in an audio file format such as mpg or wma), and icon 606 to clear all notes associated with a currently selected alert. Notes 109 may be cleared or deleted from notes panel 600, however, in some embodiments, GUI 100 may include functionality to ensure the integrity of the information entered and edited (e.g., never deleted) via the GUI. Other icons may be included on toolbar 602 to provide additional functionality.

FIG. 7 illustrates a verification pair panel of a GUI in accordance with some embodiments. Verification pair panel 700 may be a popup or selectable panel to display corresponding portions of a reference image and a later-captured image associated with a currently selected alert, such as selected alert 111 (FIG. 1), in a side-by-side manner. In some embodiments, verification pair panel 700 may display the original unprocessed and/or unregistered images for the currently selected alert to allow an analyst to compare the reference image and the recently captured image in alert windows 704 and 706 free of any possible processing-induced artifacts.

Verification pair panel 700 may include toolbar 702 having icons, which when selected, may result in the performance of certain functions. For example, toolbar 702 may include an icon to close or hide the panel, an icon to zoom out from the image, an icon to reset the image to a predetermined resolution, an icon to zoom into the image, an icon to display the entire image subset within the image panel, and an icon to zoom the image corresponding to a user-defined box. Toolbar 702 may also include an icon to allow panning (i.e. moving) of the image, an icon to center the current image subset within the image panel, and an icon to display a zoomed image version of image data at the current cursor position to display the zoomed image on top of the image at the current cursor position. Toolbar 702 may also include an icon to display a zoomed image version of image data at the current cursor position. Toolbar 702 may also include icons to separately change the contrast and brightness of windows 704 and 706 so that the images may be better compared. In some embodiments, toolbar 702 may include icon 728 to enable measurement tool 730. Icon 728 and measurement tool 730 may operation similar to con 328 and measurement tool 330 of alert image panel 300 (FIG. 3) to indicate an actual size (e.g., in millimeters) of features in the displayed image. Other icons for additional image display functions such as pan, roam, center, zoom, etc. may also be included in toolbar 702. In some embodiments, verification pair panel 700 may include icon 703 to hide or close panel 700.

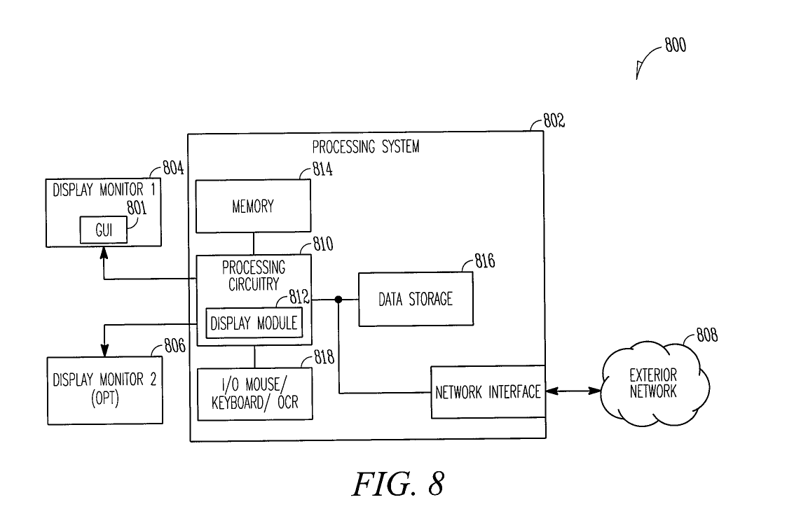

FIG. 8 is a block diagram of display system in accordance with some embodiments. Display system 800 may comprise GUI 801 which may be suitable for use in displaying and comparing skin features. GUI 100 (FIG. 1) may be suitable for use as GUI 801, although the scope of these embodiments is not limited in this respect. Display system 800 may also include processing system 802 and display monitor 804. Processing system 802 may generate signals for generating GUI 801 on display monitor 804. Processing system 802 may include processing circuitry 810, memory 814, and input-output (I/O) 818, which may be configured to operate as in a conventional computer or processing system. In some embodiments, processing circuitry 810 may include display module 812, which may be configured to cause processing system 802 to generate signals to generate and display GUI 801. Display module 812 may be a software module and may comprise software configured to run on processing system 802 to generate GUI 801, although the scope of the embodiments is not limited in this respect.

I/O 818 may be suitable to allow an analyst to manipulate the various panels of GUI 801 as discussed above with respect to FIGS. 1-7, including, among other things, the entering of notes 109 (FIG. 1) in alert notes panel 108 (FIG. 1) and the selection of one of concern levels 508 (FIG. 5).

In some embodiments, processing system 802 may include data storage element 816 which may store the various data elements for use by display module 812 in generating GUI 801. Although data storage element 816 is illustrated as being internal to processing system 802, this is not a requirement as data storage element 816, or portions thereof, may be external to processing system 802. Data storage element 816 may be any computer-readable medium. In some embodiments, a patient may retain his or her information on a computer-readable medium, such as on a compact disc and may provide this information for viewing an analyzing using system 800. Prior alerts, as well as the associated imagery and information for alert information panel 106 (FIG. 1) and alert notes panel 108 (FIG. 1) from prior patient visits may be stored in the computer-readable medium allowing the patient and/or an analyst to view changes over time.

In some embodiments, some or all of the various data elements for use by display module 812 in generating GUI 801 may be accessible over external network 808. Examples of external network 808 may include the Internet, an intranet, or other network.

In some embodiments, display system 800 may include two or more display monitors, including display monitors 804 and 806. In these embodiments, display system 800 may display GUI 801 on the two or more displays. For example GUI 801 may be displayed across two monitors, or the various panels of GUI 801 may be separately displayed on each monitor. In some example embodiments, verification pair panel 700 (FIG. 7) may display full-resolution portion of a reference image on one display, and a full-resolution portion of a corresponding later-captured image on another display.

Although display system 800 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), and combinations of various hardware and logic circuitry for performing at least the functions described herein. In some embodiments, the functional elements of display system 800 may refer to one or more processes operating on one or more processing elements.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

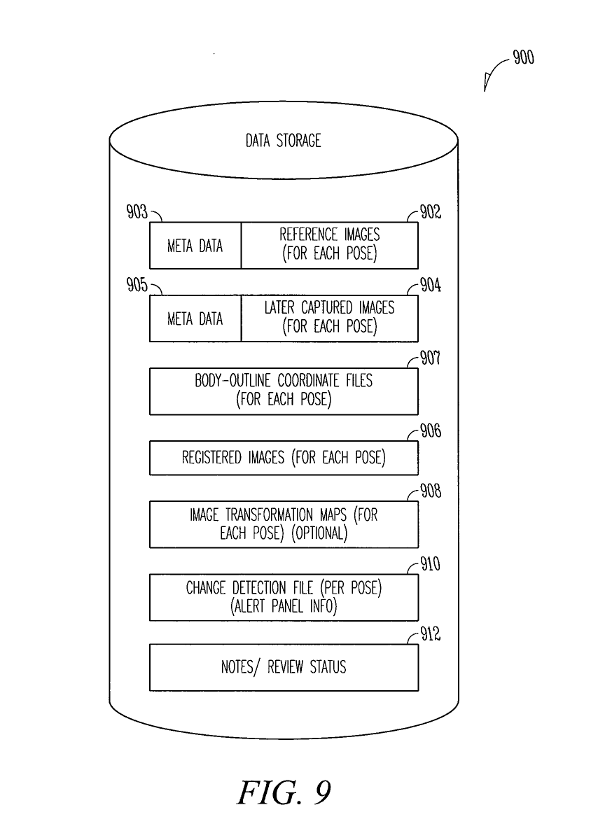

FIG. 9 illustrates a data storage element in accordance with some embodiments. Data storage 900 may be configured to store the various data elements for use in generating a GUI, such as GUI 100 (FIG. 1). Data storage 900 may correspond to data storage element 816 (FIG. 8), although other data storage elements may also be suitable. Data storage 900 may include reference images 902 and metadata 903 associated with reference images 902. Data storage 900 may also include later-captured images 904 and metadata 905 associated with each later captured image 904. Each of later-captured images 904 may correspond to one of reference images 902. In some embodiments, reference images 902 and later-captured images 904 may each comprise an image for each of the several body poses discussed above. Reference images 902 and later-captured images 904 may comprise original full-resolution images (i.e., without an image processing, prep-warping, or warping performed thereon).

Data storage 900 may also include registered images 906, which may have their features aligned and registered with the features of reference images 902. In some example embodiments, the coordinates of particular skin features within a registered image may be aligned with the coordinates of a corresponding skin feature of a corresponding reference image.

Data storage 900 may optionally also include image transformation maps 908 which may be used to generate registered images 906 from later-captured images 904 to align and register features. An image transformation map may be included for each body pose for each later-captured image. In these embodiments, registered images 906 and image transformation maps 906 may be generated by a skin-feature change detection system, such as the skin-feature change detection system disclosed in US patent application having attorney docket number 1547.051US1 referenced above, although the scope of the invention is not limited in this respect.

Data storage 900 may also include change-detection files 910. Change-detection files 910 may identify regions corresponding to alerts 110 (FIG. 1) in registered images 906 that include skin features that have been identified as changed. Change-detection files 910 may include coordinates of the region in an image that had been identified as changed. In some embodiments, change-detection files 910 may include alert data 406 (FIG. 4) for each alert 110 of a particular body pose. For example, change-detection files 910 may include the data used to populate fields 414, 416, 418, 420, 422, and 424 for display in alert information panel 400 (FIG. 4). Change-detection files may be generated by a skin-feature change detection system, such as the change detection system disclosed as part of a skin-feature change detection system disclosed in US patent application having attorney docket number 1547.051US1 referenced above. Change-detection files 910 may be used to generate a graphic overlay to display alerts 110 (FIG. 1) within pose panel 102 (FIG. 1).

Data storage 900 may also store information and images taken over time with respect to a particular patient. For example, each element in data storage 900 may include a set of information for each of a plurality of dates to allow changes in any particular portion of the body to be reviewed over time.

Data storage 900 may also include notes and review status data 912, which may comprise notes 109 (FIG. 6) entered by an analysis in alert notes panel 600 (FIG. 6) and concern level 508 (FIG. 5) selected for each alert by an analysis in spotlight-notes dialog panel 500 (FIG. 5). Notes and review status data 912 maybe associated with each alert 110 (FIG. 1) for each body pose.

In some embodiments, data storage 900 may also include body-outline coordinate files 907 which may be used to generate a body outline, such as pose image 103 (FIG. 1) within pose panel 102 (FIG. 1). Body-outline coordinate files 907 may be stored for each body pose and may have been generated by a skin-feature change detection system, such as the change detection system disclosed as part of a skin-feature change detection system disclosed in US patent application having attorney docket number 1547.051US1 referenced above. In some embodiments, data storage 900 may be configured to be compatible with medical record keeping requirements.

Although embodiments are described herein with respect to displaying corresponding skin-features, the scope of the invention is not limited in this respect. Other embodiments are suitable for displaying changes in other types of imagery. For example, some embodiments may be applicable to mammography. In these embodiments, corresponding features in a time-sequence of two or more images (e.g., mammogram radiographs) may be displayed by GUI 100 (FIG. 1). Accordingly, an objective method to display breast-anomalies for comparison is provided to help detect breast cancer.

Some embodiments may be applicable to high-resolution remote-sensing imagery. In these embodiments, high-resolution images may be taken from aircraft or satellites and alerts may be identified that correspond to areas on the ground that area of interest. In these embodiments, GUI 100 (FIG. 1) and/or system 800 (FIG. 8) may provide a way to analyze, track and compare these areas of interest over time to detect, for example, flood and fire damage, troop movements and/or weapons deployment.

Embodiments may be implemented in one or a combination of hardware, firmware, and software. Embodiments of the invention may also be implemented as instructions stored on a computer-readable medium, which may be read and executed by at least one processor to perform the operations described herein. A computer-readable medium may include any mechanism for storing or transmitting information in a form readable by a machine (e.g., a computer). For example, a computer-readable medium may include read-only memory (ROM), random-access memory (RAM), magnetic disk storage media, optical storage media, flash-memory devices, and others. In embodiments implemented on a computer-readable medium, a patient or analyst may be able to run the instructions (e.g., software) on a computer system to view and analyze the patient's imagery and data, which may be stored on a separate CD.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A graphical user interface (GUI) comprising:
a pose panel to display a pose image of one of a plurality of body poses, the pose panel further to identify one or more alerts, each alert identifying one or more skin features on the pose image;
an alert image panel to display a higher resolution portion of a body image corresponding to one of the alerts selected in the pose panel, the alert image panel to show skin features identified by the selected alert; and
an alert information panel to display alert data associated with one or more of the alerts,
wherein the selection of an alert in one of the panels causes the GUI to display data or images relevant to the selected alert in the other panels.

2. The GUI of claim 1 further comprising an alert notes panel to display notes associated with a selected alert in a text form,
wherein the pose image comprises either a body outline or a thumbnail image, and
wherein the alert information panel includes a reviewed status box to indicate a review status associated with one or more of the alerts, the reviewed status box being configured to display one of a plurality of concern levels selected for the associated alert.

3. The GUI of claim 2, wherein the GUI is configured to display a comparison between corresponding skin features of a reference image and a later-captured image based on change-detection files for review and concern-level identification by an analyst, the corresponding skin featuring having been aligned and registered by a skin-feature change detection system.

4. The GUI of claim 2 wherein the pose panel, the alert image panel, the alert information panel, and the alert notes panel are configured to systematically display alerts associated with the body poses for expedited review by an analyst.

5. The GUI of claim 2 wherein each alert identified on the pose panel outlines a region on the pose image associated with one or more skin features that have been identified as changed,
wherein the alert image panel includes a toggle feature to allow toggling between corresponding portions of the body image associated with a selected alert from the reference image and the later-captured image for comparison of corresponding skin features, and
wherein the alert image panel includes a zoom feature to expand the region associated with the selected alert.

6. The GUI of claim 2 further comprising a verification pair panel to display corresponding portions of the reference image and the later-capture image associated with a selected alert in a side-by-side manner, the verification pair panel configured to operate as a pop-up panel when selected.

7. The GUI of claim 1 wherein the portion of the body image displayed in the alert image panel is selectable by selection of an associated one of the alerts in the pose panel.

8. The GUI of claim 1 the GUI is generated by a display module configured to generate the pose image from a body-outline coordinate file for either a reference image or a later archived image.

9. The GUI of claim 2 the reviewed status box is configured to indicate a color for each of the concern levels associated with the alert,
wherein the concern levels comprise a higher concern level, a lower concern level and an unconcerned level, and
wherein the reviewed status box indicates a review status of not reviewed prior to a review of an associated alert.

10. The GUI of claim 2 further comprising a spotlight-notes dialog panel comprising a pop-up window to be displayed when one of the alerts within the alert information panel is selected, the spotlight-notes dialog panel to allow selection of one of the concern levels and to allow an addition of notes in a notes portion of the spotlight notes dialog panel,
wherein the GUI further comprises an alert notes panel to display the notes from the note portion of the spotlight-notes dialog panel associated with the alert currently selected.

11. The GUI of claim 2 wherein the GUI wherein the pose panel, the alert image panel, the alert information panel, and alert notes panel are displayed concurrently in different non-overlapping portions on a display, and
wherein when one of the panels is closed, another of the panels is configured to expand to fill-in a portion previously covered by the closed panel.

12. The GUI of claim 1 wherein the alert data displayed by the alert information panel includes:
a change type field to indicate whether the associated alert had been identified as having a color, a shape, or an area change;
a feature size field to indicate an approximate area of a skin feature associated with an alert; and
a circumference field to indicate an approximate circumference of a skin feature associated with an alert.

13. A display module comprising one or more processing elements configured to generate a graphical user interface (GUI) comprising:
a pose panel to display a pose image of one of a plurality of body poses, the pose panel further to identify one or more alerts, each alert identifying one or more skin features on the pose image;
an alert image panel to display a higher resolution portion of a body image corresponding to one of the alerts selected in the pose panel, the alert image panel to show skin features identified by the selected alert; and
an alert information panel to display alert data associated with one or more of the alerts,
wherein the selection of an alert in one of the panels causes the GUI to display data or images relevant to the selected alert in the other panels.

14. The display module of claim 13 further configured to generate an alert notes panel as part of the GUI, the alert notes panel configured to display notes associated with a selected alert in a text form,
wherein the pose image comprises either a body outline or a thumbnail image, and
wherein the alert information panel includes a reviewed status box to indicate a review status associated with one or more of the alerts, the reviewed status box being configured to display one of a plurality of concern levels selected for the associated alert.

15. The display module of claim 14, wherein the GUI is configured to display a comparison between corresponding skin features of a reference image and a later-captured image based on change-detection files for review and concern-level identification by an analyst, the corresponding skin featuring having been aligned and registered by a skin-feature change detection system.

16. The display module of claim 14 wherein the pose panel, the alert image panel, the alert information panel, and the alert notes panel are configured to systematically display alerts associated with the body poses for expedited review by an analyst.

17. The display module of claim 14 comprising a plurality of software-configured processing elements configured to generate and concurrently display the pose panel, the alert image panel, the alert information panel, and the alert notes panel, and configured to expand to fill-in a portion on a display previously covered by a closed panel when one of the panels is closed.

18. A method of generating a graphical user interface (GUI) to display corresponding skin features comprising:
generating a pose panel to display a pose image of one of a plurality of body poses, the pose panel further to identify one or more alerts, each alert identifying one or more skin features on the pose image;
generating an alert image panel to display a higher resolution portion of a body image corresponding to one of the alerts selected in the pose panel, the alert image panel to show skin features identified by the selected alert; and
generating an alert information panel to display alert data associated with one or more of the alerts,
wherein the selection of an alert in one of the panels causes the GUI to display data or images relevant to the selected alert in the other panels.

19. The method of claim 18 further comprising generating an alert notes panel to display notes associated with a selected alert in a text form,
wherein the pose image comprises either a body outline or a thumbnail image, and
wherein the alert information panel is generated to include a reviewed status box to indicate a review status associated with one or more of the alerts, the reviewed status box being configured to display one of a plurality of concern levels selected for the associated alert.

20. The method of claim 19 wherein the GUI is configured to display a comparison between corresponding skin features of a reference image and a later-captured image based on change-detection files for review and concern-level identification by an analyst, the corresponding skin featuring having been aligned and registered by a skin-feature change detection system.

21. The method of claim 19 comprising systematically displaying alerts associated with the body poses for expedited review by an analyst in the pose panel, the alert image panel, the alert information panel, and the alert notes panel.

22. A computer-readable medium that stores instructions for execution by one or more processors to generate a graphical user interface by performing operations comprising:
generating a pose panel to display a pose image of one of a plurality of body poses, the pose panel further to identify one or more alerts, each alert identifying one or more skin features on the pose image;
generating an alert image panel to display a higher resolution portion of a body image corresponding to one of the alerts selected in the pose panel, the alert image panel to show skin features identified by the selected alert; and
generating an alert information panel to display alert data associated with one or more of the alerts.

23. The computer-readable medium of claim 22 wherein the instructions, when further implemented causes the one or more possessors to perform operations comprising generating an alert notes panel to display notes associated with a selected alert in text form,
wherein the pose image comprises either a body outline or a thumbnail image, and
wherein the alert information panel is generated to include a reviewed status box to indicate a review status associated with one or more of the alerts, the reviewed status box being configured to display one of a plurality of concern levels selected for the associated alert.

24. The computer-readable medium of claim 23 wherein the GUI is configured to display a comparison between corresponding skin features of a reference image and a later-captured image based on change-detection files for review and concern-level identification by an analyst, the corresponding skin featuring having been aligned and registered by a skin-feature change detection system.

25. The computer-readable medium of claim 23 wherein the instructions, when further implemented causes the one or more possessors to perform operations comprising systematically displaying alerts associated with the body poses for expedited review by an analyst in the pose panel, the alert image panel, the alert information panel, and the alert notes panel, and
wherein the selection of an alert in one of the panels causes the GUI to display data or images relevant to the selected alert in the other panels.
